(19) United States
(12) Patent Application Publication
(10) Pub. No.: US 2020/0287229 A1
(43) Pub. Date: Sep. 10, 2020

(54) DUAL FIBER ELECTRODE MATS FOR BATTERIES AND APPLICATIONS OF SAME

(71) Applicant: VANDERBILT UNIVERSITY, Nashville, TN (US)

(72) Inventor: Peter N. PINTAURO, Brentwood, TN (US)

(21) Appl. No.: 16/064,137

(22) PCT Filed: Feb. 24, 2017
(86) PCT No.: PCT/US2017/019314

§ 371 Date: Jun. 20, 2018

Related U.S. Application Data
(63) Continuation-in-part of application No. 15/161,836, filed on May 23, 2016, now Pat. No. 10,352,600.
Application No. 15/161,836 is a continuation-in-part of application No. 14/964,220, filed on Dec. 9, 2015, now Pat. No. 9,876,246.
Application No. 14/964,220 is a continuation of application No. 13/823,968, filed on Mar. 15, 2013, now Pat. No. 9,905,870.
(60) Provisional application No. 62/299,268, filed on Feb. 24, 2016.

(51) Int. Cl. H01M 8/1004; D01D 5/00; B29C 48/05; H01M 8/102; H01M 8/1039; H01M 4/88; H01M 4/90; H01M 4/92

(52) U.S. Cl. CPC H01M 8/1004; D01D 5/003; B29C 48/05; D01D 5/0007; H01M 8/102; H01M 2008/1095; H01M 4/8853; H01M 4/8864; H01M 4/8896; H01M 4/9041; H01M 4/926; H01M 8/1039

(57) ABSTRACT

A dual fiber mat for making an electrode includes first nanofibers and second nanofibers. The first fibers contain particles for electrochemical reaction and a binder. The second fibers contain particles for electron conduction and a binder. For a Li-ion battery anode, the first fibers include a polymer binder composed of an electron conducting polyfluorene derivative polymer (PFM or PEFM) or PVDF or PAA and silicon nanoparticles or silicon nanorods embedded in the binder. For a Li-ion battery cathode, the first fibers include a binder composed of an electron conducting polymer (PFM or PEFM) or PAA or PVDF and LiCoO2 or LiFePO4 or Li2MnO3 particles embedded in the binder. The second nanofibers include a PFM or PEFM binder or non-conductive polymer binder and electrically conductive nanoparticles embedded in the binder. The dual fiber mat has a thickness in a range of about 50-1000 μm.

### CROSS-REFERENCE TO RELATED PATENT APPLICATIONS

This PCT application claims priority to and the benefit of U.S. Provisional Patent Application Ser. No. 62/299,268, filed Feb. 24, 2016.

This application also is a continuation-in-part application of U.S. application Ser. No. 15/161,838, filed May 23, 2016.

This application also is a continuation-in-part of U.S. application Ser. No. 14/964,220, filed Dec. 9, 2015.

This application also is a continuation-in-part of U.S. patent application Ser. No. 13/823,968, filed Mar. 15, 2013.

All the above disclosures of which are incorporated herein in their entireties by reference.

Some references, which may include patents, patent applications, and various publications, are cited and discussed in the description of the present invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### STATEMENT AS TO RIGHTS UNDER FEDERALLY-SPONSORED RESEARCH

The present invention was made with government support under Contract No. DE-EE0007215 awarded by the U.S. Department of Energy's Office of Energy Efficiency & Renewable Energy. The government has certain rights in the invention.

### FIELD OF THE INVENTION

The present invention relates generally to a battery electrode, and more specifically related to a fiber electrode mat having two or more different fibers.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

Fossil fuels are currently the predominant source of energy in the world. Due to concerns such as carbon dioxide emissions and the finite nature of the supply of fossil fuel, research and development and commercialization of alternative sources of energy have grown significantly over the past decades. One focus of research and development is batteries. However, it is a challenge to manufacturing batteries with high energy capacity.

Therefore, a heretofore unaddressed need exists in the art to address the aforementioned deficiencies and inadequacies.

### SUMMARY OF THE INVENTION

In one aspect, the present invention relates to a dual fiber mat for making an electrode. In certain embodiments, the dual fiber mat is formed by co-spinning of first type of nanofibers and second type of nanofibers. The first type of nanofibers comprises a conductive or non-conductive polymer binder and particles which participate in an electrochemical reaction. For example, the binder could contain polyfluorene derivative polymer (poly(9,9-dioctylfluorene-co-fluorenone-co-methylbenzoic ester) (PFM), PEFM, or modifications thereof) and the particles are silicon nanoparticles embedded in the PFM. The second type of nanofibers comprises a conductive or non-conductive polymer binder and electrically conductive nanoparticles that are embedded in the polymer binder. The dual fiber mat has a thickness in a range of about 5-1000 μm.

In certain embodiments, the particles for electrochemical reaction are Si particles for Li⁺ ion intercalation.

In certain embodiments, the conductive nanoparticles comprise at least one of carbon nanoparticles and copper nanoparticles.

In certain embodiments, the non-conductive polymer binder comprises at least one of polyacrylic acid (PAA) and polyvinylidene fluoride (PVDF).

In certain embodiments, the first type of nanofibers and the second type of nanofibers are distributed evenly in the fiber mat, such that the second type of fibers form fiber-fiber contact with the first type of fibers, and provide numerous node points and pathways for electrons to pass to/from the particles where an electrochemical reaction is occurring.

In certain embodiments, a diameter of the first type of nanofiber is less than about 1 μm.

In certain embodiments, the dual fiber mat comprises about 50-80% of the first type of nanofibers and about 20-50% of the second type of nanofibers. In certain embodiments, the second type of nanofibers comprises about 30-80% of the electrically conductive nanoparticles.

In another aspect, the present invention relates to a dual fiber mat. In certain embodiments, the dual fiber mat comprises first type of fibers having a first particle material and a first polymer; and second type of fibers having a second particle material and a second polymer.

In certain embodiments, the first particle material comprises first nanoparticles or first nanorods. In certain embodiments, the first particle material comprises silicon nanoparticles or silicon nanorods.

In certain embodiments, each of the first polymer and the second polymer comprises PFM, PAA, or PVDF

In certain embodiments, the second particle material comprises electrically conductive particles. In certain embodiments, the second particle material comprises carbon nanoparticles or copper nanoparticles.

In certain embodiments, the second polymer has a formula of:

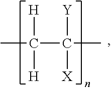

where each of X and Y is selected from the group consisting of —H, —OH, —COOH, and halide, such as —F.

In certain embodiments, the second polymer comprises at least one of PAA and PVDF.

In certain embodiments, the first particle in LiCoO₂ and the first polymer is PVDF.

In certain embodiments, the first particle is TiO₂ and the first polymer is PAA.

In certain embodiments, the first type of fibers is silicon/PAA and the second type of fibers is carbon/PAA.

In certain embodiments, the dual fiber mat is used as the anode or cathode in a metal ion battery, such as a Li-ion battery, or a fuel cell or a water electrolyzer or an electrochemical/chemical sensor.

In certain embodiments, the first type of fibers and the second type of fibers are distributed evenly in the fiber mat, such that the second type of fibers form fiber-fiber contact with the first type of fibers, and provide numerous node points and pathways for electrons to pass to/from the first nanoparticles or the first polymer to a metal plate of the electrode.

In certain embodiments, the dual fiber mat is formed by co-spinning of the first type of fibers and the second type of fibers. In certain embodiments, a thickness of the dual fiber mat is about 5-1000 μm, and an average diameter of the first type of fibers is less than about 1 μm.

In certain embodiments, the dual fiber mat comprises about 50-80% of the first type of fibers and 20-50% of the second type of fibers. In certain embodiments, the second type of fiber comprises about 30-80% of the second particles.

In a further aspect, the present invention relates to a multiple fiber mat electrode having a multiple fiber mat. In certain embodiments, the mat has two or more different fibers, containing different particles and/or polymer binders.

In certain embodiments, the electrode is used in an electrochemical device or process.

In certain embodiments, the electrochemical device is a battery.

In certain embodiments, the electrochemical device is a fuel cell.

In certain embodiments, the electrochemical device is a water electrolyzer.

In certain embodiments, the electrochemical device is an electrochemical reactor.

In certain embodiments, the electrochemical device is a sensor.

In a further aspect, the present invention relates to a method of manufacturing a dual fiber mat for an electrode. In certain embodiments, the method comprises providing a first solution having a first polymer and a first particle material, and a second solution having a second polymer and a second particle material, and co-spinning the first solution and the second solution to respectively form first type of fibers and second type of fibers, so as to form the dual fiber mat.

In certain embodiments, the first particle comprises a material where electrochemical reactions occur.

In certain embodiments, the first particle material comprises silicon nanoparticles or silicon nanorods. In certain embodiments, the first polymer comprises PFM or PEFM or modification thereof, PAA, or PVDF.

In certain embodiments, a carrier polymer is added first polymer to assist in the formation of fibers.

In certain embodiments, the first particle material comprises LiCoO₂ or Li₂MnO₃ or LiFePO₄, sulfur-loaded carbon, where the dual fiber electrode is used as a cathode in a Li-ion battery.

In certain embodiments, the first particle material is Si, carbon, graphite, or TiO₂, where the dual fiber electrode is used as an anode in a Li-ion battery.

In certain embodiments, the second particle material comprises electrically conductive particles. In certain embodiments, the electrically conductive particles comprise carbon nanoparticles or copper nanoparticles. In certain embodiments, the second polymer comprises a polyfluorene derivative polymer (PFM or PEFM), PAA, or PVDF.

In certain embodiments, the dual fiber mat has a thickness of about 50-1000 μm. In certain embodiments, an average diameter of the first type of fibers is less than about 1 μm.

In certain embodiments, the dual fiber mat contains about 50-80% of the first type of fibers and about 20-50% of the second type of fibers. In certain embodiments, the second type of fiber comprises about 30-80% of the second particles.

In certain embodiments, the first type of fibers is silicon/PFM or silicon/PEFM fibers (with or without a suitable carrier polymer), and the second type of fibers is carbon/PVDF fibers.

In certain embodiments, the first type of fibers is silicon/PAA and the second type of fibers is carbon/PAA.

In certain embodiments, the first type of fibers are a supported precious metal or metal alloy containing catalyst powder (where the support includes carbon, SiO₂, and TiO₂) and the first polymer is a proton conducting polymer or a hydroxide ion conducting polymer.

In certain embodiments, the method further comprises providing a third, fourth, or fifth solution (or more) having a third, fourth, or fifth (or more) particle material and a third, fourth or fifth (or more) polymer. The multiple solutions are co-spun with the first solution and the second solution to form multiple fibers. The multiple particle materials comprises at least one of silicon nanoparticles, silicon nanorods, carbon nanoparticles, copper nanoparticls, Pt/C, Pt-alloy/C, a zeolite catalyst or a supported metal catalyst, and the multiple polymers comprises at least one of PFM or PEFM with a suitable carrier, PAA, and PVDF, or a charged anion-exchange or cation exchange polymer.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the present invention and, together with the written description, serve to explain the principles of the invention. Wherever possible, the same reference numbers are used throughout the drawings to refer to the same or like elements of an embodiment.

FIG. 1A is a schematic view of a dual fiber mat according to one embodiment of the present invention, where first type of fibers and second type of fibers are randomly distributed in the dual fiber mat.

FIG. 1B shows the first type of fiber in FIG. 1A.

FIG. 1C shows the second type of fiber of FIG. 1A.

FIG. 2A is a schematic view of a dual fiber mat according to one embodiment of the present invention, where first type of fibers and second type of fibers are distributed in the dual fiber mat with a pattern.

FIG. 2B shows the first type of fiber in FIG. 2A.

FIG. 2C shows the second type of fiber of FIG. 2A.

FIG. 3 shows a method of manufacturing a dual fiber mat according to one embodiment of the present invention.

FIG. 4 shows a scanning electron microscope (SEM) image of a compacted/welded electrospun dual fiber mat anode containing Si/PAA and C/PAA fibers in a weight ratio of 65/35 according to one embodiment of the present invention.

FIG. 5 shows Li-ion battery half-cell charge-discharge curves for the first and second cycles with a Li metal cathode and an electrospun dual fiber mat anode containing 50 wt % Si/PAA fibers and 50 wt. % C/PAA fibers, where the Si/PAA fibers contain 65 wt % Si particles and the C/PAA fibers contain 65 wt. % C particles according to one embodiment of the present invention.

FIG. 6 shows repeat unit structure of PEFM binder containing (P) polyfluorene with octyl side chains, (E) fluorine with trietyleneoxide monomethylether side chains, (F) fluorenone and (M) methyl benzoate ester subunits.

FIG. 7 shows structure of poly(9,9-dioctylfluorene-co-fluorenone-co-methylbenzoic ester), that is PFM.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

In one aspect, the present invention is related to a multiple fiber mat for manufacturing a battery electrode. The multiple fiber mat is composed of two or more different type of fibers. Each type of the fibers contains particles and polymer. The different types of fibers have different particles and/or polymer binders. In another aspect, the present invention relates to a process for making the multiple fiber mat. By preparing the fiber mat this way, the present invention allows for a thick battery electrode. For example, this invention allows for a thick Lithium (Li) battery electrode (high areal capacities) with a controlled void volume (for electrolyte penetration and high volumetric capacities) and short Li+ ion transport pathways in the radial fiber direction (for fast charge/discharge rates).

In certain embodiments, the multiple fiber mat of the invention can be applied to other battery systems, e.g., metal batteries including Na or magnesium batteries. In certain embodiments, the multiple fiber mat of the present invention may be used in high energy density metal-air batteries, e.g., Li-air batteries, and redox flow batteries.

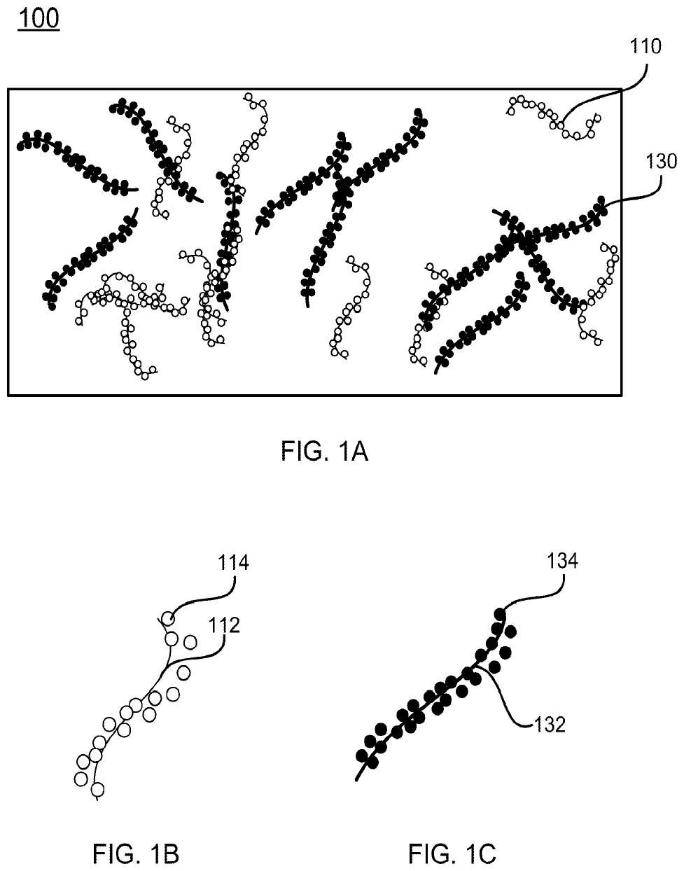

FIG. 1A is a schematic view of a dual fiber mat (one type of multiple fiber mat) according to one embodiment of the present invention, where first type of fibers and second type of fibers are randomly distributed in the fiber mat. As shown in FIG. 1A, a dual fiber mat electrode 100 is formed from first type of fibers 110 and second type of fibers 130. The first type of fibers 110 and the second type of fibers 130 are randomly distributed in the fiber mat 100. In certain embodiments, the weight percentage of the first type of fibers 110 in the dual fiber mat 100 is about 50%-80, and the weight percentage of the second type of fibers 130 in the dual fiber mat 100 is about 20%-50%.

Referring to FIG. 1B, the first type of fibers 110 includes a first polymer 112 and first particles 114 attached to or embedded in the first polymer 112. In certain embodiments, the first polymer 112 is an electrically conductive binder, such as a polyfluorene derivative polymer (PFM or PEFM with/without a suitable carrier polymer), and the first particles 114 may be silicon (Si) nanoparticles or Si nanorods.

Referring to FIG. 1C, the second type of fibers 130 includes a second polymer 132 and second particles 134 attached to the second polymer 132. In certain embodiments, the second polymer 132 may be an electrically conductive binder, such as PFM, or a non-conductive polymer binder, such as PAA or PVDF; the second particles 134 may be electrically conductive particles, such as carbon or Cu nanoparticles.

In certain embodiments, the second polymer has the formula of:

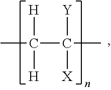

where each of X and Y is selected from the group consisting of —H, —OH, —COOH, and halide such as —F. In one example, X is —H, Y is —COOH, and the second polymer is PAA. In another example, both X and Y are —F, and the second polymer is PVDF.

In certain embodiments, the first type of fibers 110 and the second type of fibers 130 may be co-spun to form the dual fiber mat 100. In the dual fiber mat 100, the second type of fibers 130 make fiber-fiber contact with the first type of fibers 110, thus providing numerous node points and pathways for electrons to pass to/from Si surface and or the PFM polymer to a metal plate current collector at the back of the electrode.

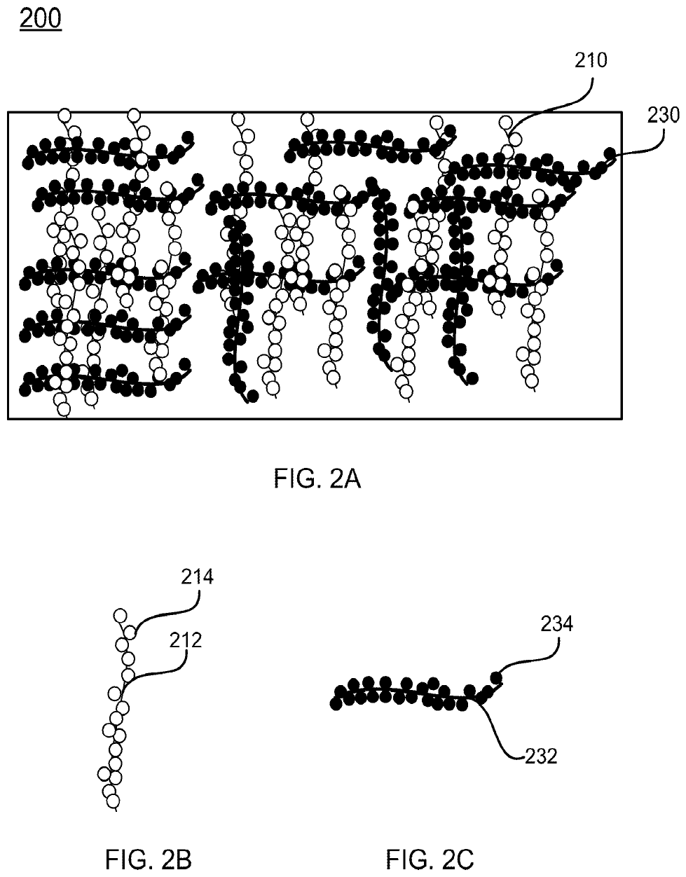

FIG. 2A is a schematic view of a fiber mat according to one embodiment of the present invention, where first type of fibers and second type of fibers are distributed in the dual fiber mat with a pattern. As shown in FIG. 2A, a dual fiber mat 200 is formed from first type of fibers 210 and second type of fibers 230. The first type of fibers 210 and the second type of fibers 230 are distributed in the fiber mat 200 with a pattern. In certain embodiments, the weight percentage of the first type of fibers 210 in the fiber mat 100 is about 50%-80, and the weight percentage of the second type of fibers 230 in the fiber mat 200 is about 20%-50%.

Referring to FIG. 2B, the first type of fibers 210 includes a first polymer 212 and first particles 214 attached to the first polymer 212. In certain embodiments, the first polymer 212 is an electrically conductive binder, such as PFM, and the first particles 214 may be Si nanoparticles or Si nanorods.

Referring to FIG. 2C, the second type of fibers 230 includes a second polymer 232 and second particles 234 attached to the second polymer 232. In certain embodiments, the second polymer 232 may be an electrically conductive binder, such as PFM, or a non-conductive polymer binder, such as PAA or PVDF; the second particles 234 may be electrically conductive particles, such as carbon or Cu particles.

In certain embodiments, the first fibers 210 and the second type of fibers 230 may be co-spun to form the dual fiber mat 200. In the dual fiber mat 200, the second type of fibers 230 make fiber-fiber contact with the first type of fibers 210, thus providing numerous node points and pathways for electrons to pass to/from Si surface and or the PFM polymer to a metal plate current collector at the back of the electrode.

In certain embodiments, the first type of fibers 210 and the second type of fibers 230 are distributed in the fiber mat 200 with patterns. For example, in one pattern, the first type of fibers 210 are substantially disposed in a vertical direction, while the second type of fibers 230 are disposed in a horizontal direction that is substantially perpendicular to the vertical direction. In certain embodiments, the first type of fibers 210 and the second type of fibers 230 are evenly distributed in the fiber mat 200. In certain embodiments, the first type of fibers 210 and the second type of fibers 230 may be in the form of layers, and the layers of the first type of fibers 210 and the layers of the second type of fibers 230 are alternatively disposed.

In certain embodiments, the first polymer 212 has the formula of:

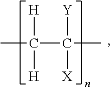

where each of X and Y is selected from —H, —OH, —COOH, and a halide such as —F, and n is a positive integer. In certain embodiments, the first polymer 212 includes at least one of PAA, or PVDF.

In certain embodiments, the first polymer 212 has the formula of:

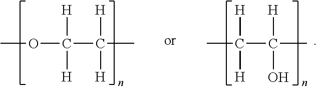

In certain embodiments, the first polymer 212 includes a poly(ethylene oxide) (PEO) or polyvinyl alcohol.

In certain embodiments, the second polymer 214 has the formula of:

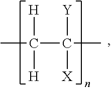

where each of X and Y is selected from —H, —OH, —COOH, and a halide such as —F, and n is a positive integer. In certain embodiments, the second polymer 232 includes at least one of PAA, or PVDF.

In certain embodiments, the second polymer 232 has the formula of:

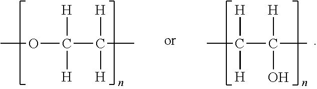

In certain embodiments, the second polymer 232 includes PEO or polyvinyl alcohol.

In certain embodiments, the first type of fibers 210 is different from the second type of fibers 230.

In certain embodiments, in addition to the first polymer 212 and the first particle material 214, the first solution may further includes another polymer, such as an unchanged polymer such as polyphenlysulfone, and/or an ionically conductive polymer such as perfluorosulfonic acid polymer. In certain embodiments, the first solution may further include a catalyst, such as a platinum (Pt) catalyst.

In certain embodiments, in addition to the second polymer 232 and the second particle material 234, the second solution may further includes another polymer, such as an unchanged polymer such as polyphenlysulfone, and/or an ionically conductive polymer such as perfluorosulfonic acid polymer. In certain embodiments, the second solution may further include a catalyst, such as a Pt catalyst.

In certain embodiments, the dual fiber mat may further include third fibers having a third particle material and a third polymer. The third particle material may include at least one of silicon nanoparticles, silicon nanorods, carbon nanoparticles, and copper nanoparticls, and the third polymer may include at least one of PFM, PEFM, PAA, and PVDF.

In certain embodiments, the first type of fibers 210, the second type of fibers 230, and the third fibers are different from each other.

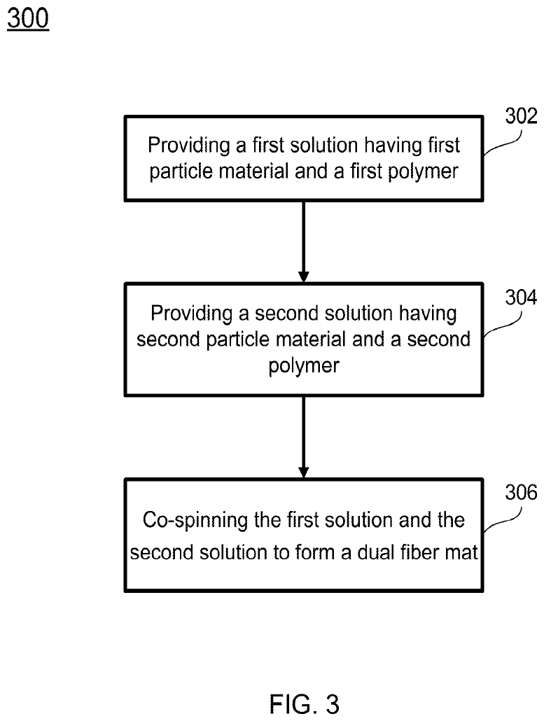

In certain aspects, the present invention relates to a method of manufacturing a dual fiber mat. In certain embodiments, as shown in FIG. 3, the method 300 includes the following steps. At operation 302, a first solution is provided. The first solution may include a first particle material and a first polymer as described above. The first particle material may be silicon nanoparticles or silicon nanorods. The first polymer may be PFM or PEFM.

At operation 304, a second solution is provided. The second solution may include a second particle material and a second polymer as described above. The second particle material may include electrically conductive particles, such as carbon nanoparticles or copper nanoparticles. The second polymer may include PFM, PEFM or a non-conductive polymer binder PAA or PVDF.

Once the first solution and the second solution are prepared, at operation 306, the first solution and the second solution are used to perform co-spinning to form a dual fiber mat. Co-spinning of the first and second solutions may be performed with a variety of electrospinning apparatuses or devices. For example, each of the first solution and the second solution is respectively filled into one of two syringes. Each of the syringes has a needle. A target is positioned with a predetermined distance to the needles. The needles are respectively connected to a power supply, and the target is grounded. During co-spinning, an electrical potential is applied to each of the needles for drawing out the corresponding solutions in the syringes toward the target. The flow rates for each solution and the electrical potentials applied to each of the needles may be controlled separately and differently such that the electrospinning for both the first and second solutions may be performed simultaneously to achieve co-spinning. As the drawn out solutions travel through the air, at least a portion of the solvent evaporates, resulting in the first type of fibers and the second type of fibers. The first type of fibers and the second type of fibers may be then collected by a rotating cylinder of the target. Thus, the first type of fibers and the second type of fibers may be obtained and organized to form the dual fiber mat for further processing.

It should be particularly noted that, unless otherwise stated in the present invention, the steps of the method may be arranged in a different sequential order, and are thus not limited to the sequential order as shown in FIG. 3. For example, the first solution is prepared first, and then the second solution is prepared; or the second solution is prepared first, and then the first solution is prepared; or the first solution and the second solution are prepared at the same time.

In certain embodiments, the method further includes a step of further processing the dual fiber mat. The further processing may include mechanical compaction and interfiber welding of intersecting fibers.

In certain aspects, the manufactured dual or multiple fiber mat is used to make an anode or an cathode in an electrochemical device.

These and other aspects of the present invention are further described in the following section. Without intending to limit the scope of the invention, further exemplary implementations of the present invention according to the embodiments of the present invention are given below. Note that titles or subtitles may be used in the examples for the convenience of a reader, which in no way should limit the scope of the invention. Moreover, certain theories are proposed and disclosed herein; however, in no way should they, whether they are right or wrong, limit the scope of the invention so long as the invention is practiced according to the invention without regard for any particular theory or scheme of action.

### EXAMPLE 1

### Si Anode for Li-Ion Batteries

In this example, the present invention provides a Si particle anode for Li-ion batteries. Si nanoparticles or nanorods are embedded in an electrically conductive binder, such as a polyfluorene derivative polymer (PFM). Although this binder is electrically conductive, the conductivity may not be sufficiently high for use in a thick anode (with high energy density). The max thickness of a Si anode with PFM may be only about 5-10 microns (μm), whereas anodes may be needed with a thickness of about 50-1000 μm.

In certain embodiments, nanofiber anodes have been electronspun with Si nanoparticles and Si nanorods and PFM polymer.

In certain embodiments, nanofiber Si/PFM anodes has been tested in Li-ion battery coin cells, in terms of energy capacity, cycle life, and charge/discharge rates.

In one embodiment, PFM electrically conductive polymer is provided by L. Gao, Lawrence Berkeley National Lab. In one embodiment, Si nanorods are provided by Professor Sreeram Vaddiraju from Texas A&M.

### EXAMPLE 2

### Dual Fiber Mats

In this example, partially to make an anode with a thickness of about 50-1000 μm, two different fibers are co-spun to form dual fiber mats for an electrode. The electrode may be anode or cathode.

The first type of fibers may be Si/PFM fibers that contain Si nanoparticles or nanorods embedded in PFM or other electrically conductive binder. The second type of fibers contains electrically conductive particles, such as carbon or Cu particles. In certain embodiments, those particles are nanoparticles. The second type of fibers further contains a polymer. The polymer may be PFM, PEFM,or a non-conductive polymer binder, such as PAA or PVDF.

The second type of fiber mat will make fiber-fiber contact with the Si-containing fibers, thus providing numerous node points and pathways for electrons to pass to/from the Si surface and or the PFM polymer to a metal plate current collector at the back of the electrode. This second co-spun fiber provides electric conductivity for a thick nanofiber mat electrode with high areal and volumetric energy densities.

In certain embodiments, the use of a Si/PFM fiber for lithium ion intercalation/de-intercalation with a fiber diameter <1 μm will ensure high Li+ transport rates into and out of the porous fiber mat and fast charge/discharge reaction times.

In certain embodiments, dual fiber electrospinning has been used to prepare membranes and electrodes for fuel cells.

### EXAMPLE 3

### Dual Fiber Mats with High Concentration of Si Particles

In certain embodiments, a dual fiber mat is provided. The dual fiber mat is manufactured from co-electrospinning of two different fibers. The first type of fibers contains Si nanoparticles or nanorods embedded in PFM or another electrically conductive binder. The second type of fibers contains electrically conductive particles, such as carbon or Cu particles embedded in PFM, PEFM or a non-conductive polymer binder, such as PAA or PVDF. By co-spining the first type of fibers and the second type of fibers, dual fiber mats are manufactured.

In one example, the first type of fibers is Si/PFM fibers and the second type of fibers is carbon/PVDF fibers. The dual fiber mats contains about 50-80% of the first type of fibers of Si/PFM, and about 20¬50% of the second type of fibers of carbon/PVDF (or some other conductive particle in a polymer binder). The second type of fibers has a very high loading (30-80%) of carbon nanoparticles to ensure a high electrical conductivity. A percolation threshold of electrically conductive nanofibers (i.e., about 30 vol %) may not be needed here, so the system offers important advantages, as compared to adding conducting carbon particles directly to the Si/PFM fibers to boost the electrical conductivity of these fibers.

### EXAMPLE 4

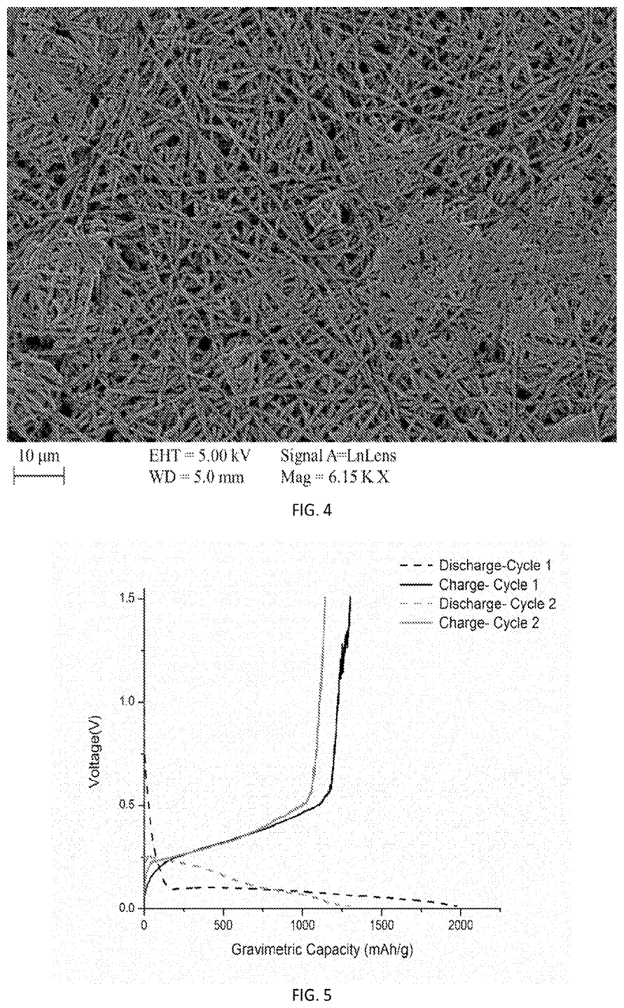

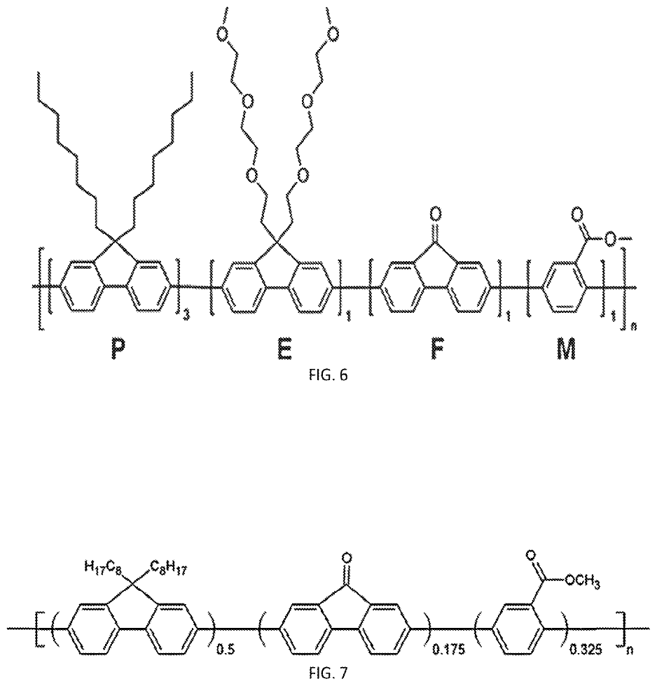

A dual fiber electrospinning setup consists of two different electrospinning inks. One of the inks is prepared by mixing Si nanoparticles (50-70 nm diameter) with poly(acrylic acid), abbreviated as PAA (450 kDa molecular weight) in a solvent mixture of isopropanol, butanol and methanol, while the second type of fiber ink is prepared by mixing conductive carbon black powder (Vulcan XC-72R) with PAA in 1-propanol as the solvent. Both inks have a total solids content of 15 wt. %, with the weight ratio of the Si:PAA and C:PAA in each of the respective inks is 65:35. The inks were electrospun at room temperature and 20% relative humidity using separate single needle spinnerets at the following conditions: (i) a flow rate of 0.75 mL/hr for both inks, (ii) 8 kV bias voltage for both inks, and (iii) 8 cm spinneret-to-collector distance for both inks. After electrospinning, multiple dual fiber Si/PAA-C/PAA mats were stacked to obtain a Si areal loading of 1.08 mg/cm². The stack was then compacted on a hydraulic press at a pressure of 90 MPa, and interfiber contacts were welded by exposing the compacted mat to methanol vapor at room temperature for 1 hour. Since the inks were spun at the same flow rate (i.e., the mat contains 50% Si/PAA fibers and 50% C/PAA fibers) with the same ink composition, the Si:C weight ratio was 1:1 in the final fabricated mat. These fiber mats were then tested as the working electrode (anode) in CR2032 Li-ion battery half cell using a Li metal counter/reference electrode (cathode), a Celgard 2500 separator, and an electrolyte containing 1.2 M LiPF₆ in 3/7 EC/DEC with 30 wt. % FEC additive. FIG. 4 shows an SEM image of the compacted and welded electrospun Si/PAA+C/PAA dual fiber mat. The two fiber types are indistinguishable.

FIG. 5 shows a representative charge/discharge curve of the first two cycles for the dual fiber mat anode at a charge/discharge rate of 0.1 C. This electrospun dual fiber mat electrode contained 50% Si/PAA fibers and 50% C/PAA fibers (a 1:1 weight ratio of Si:C, where the overall electrode weight ratio of Si:C:PAA was 32.5:32.5:65. During the first cycle, the coulombic efficiency was ˜66% due to formation of a solid-electrolyte interphase (SEI) layer on the anode surface. The coulombic efficiency rose to 87% during the second cycle. At the end of the second cycle, the gravimetric capacity of the anode was 1300 mAh/g_{electrode}, (g_{electrode} includes the weight of si, C, and PAA), corresponding to a Si gravimetric capacity of 3597 mAh/g_{Si}, thereby indicating excellent Si material utilization.

This example shows that one can have an electrochemically active (but non-electrically conductive) particles in one fiber (non-conducting Si particles) and have a second type of fiber type in an electrode mat that conducts electrons (the fibers containing C and PAA). The excellent Si utilization (3598 mAh/g_{Si}) means that electrons were passing through the C/PAA fiber and entering/exiting the Si/PAA fiber where they were participating in Li⁺ intercalation de-intercalation reactions.

In summary, certain embodiments of the present invention, among other things, have the following advantages:

1. Electrospinning Si with an electrically conductive binder at a Si particle content >60%.

2. The dual fiber electrode concept with:

(i) One fiber for lithiation/de-lithiation of Si, where Si nanoparticles are embedded in an electrically conductive and chemically stable polymer (such as PFM or PEFM) or embedded in a non-conductive and chemical stable polymer (such as PAA or PVDF) and

(ii) the second type of fiber distributed uniformly or non-uniformly throughout the electrodes and composed of electrically conductive particles (e.g., carbon or Cu) in an inert polymer binder (e.g., poly(acrylic acid), carboxymethyl cellulose, or PVDF) or in a conductive PFM or PEFM binder, where the particle content is sufficiently high to provide good electron conduction (good electrical conductivity; much better than the electrically conductive polymer binder alone).

3. Electrospinning fibers with Si nanorods.

4. The technology is applicable to both anodes and cathodes in a Li-ion battery. For the latter case, electrically conductive particles are intermixed with fibers containing lithium cobalt oxide or lithium iron phosphate, for example, and PVDF.

5. The technology can be used in batteries other than a Li-ion battery.

6. The technology can be used in a proton exchange membrane or alkaline fuel cell or in a water electrolyzer.

The foregoing description of the exemplary embodiments of the present invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A multiple fiber mat for making an electrode, comprising:
a first type of nanofibers comprising an electrically conductive nanoparticles embedded in a polymer binder; and
one or more types of nanofibers comprising one or more electrochemically active nanoparticles with one or more polymer binders,
where the one or more types of nanofibers and the first type of nanofiber are distinguishable in terms of particle/polymer compositions.

2. The multiple fiber mat of claim 1, wherein the multiple fiber mat has a thickness of about 5-1000 μm.

3. The multiple fiber mat of claim 1, wherein the multiple fiber mat is a dual fiber mat composed of two different types of fibers, and the dual fiber mat comprises:
the first type of type of nanofibers, comprising a polyfluorene derivative polymer (PFM or PEFM) and silicon nanoparticles embedded in the PFM or PEFM; and
a second type of nanofibers, comprising a non-conductive polymer binder and electrically conductive nanoparticles embedded in the non-conductive polymer binder.

4. The dual fiber mat of claim 3, wherein the dual fiber mat has a thickness in a range of about 5-1000 μm.

5. The dual fiber mat of claim 3, wherein the electrically conductive nanoparticles comprises at least one of carbon nanoparticles and copper nanoparticles.

6. The dual fiber mat of claim 3, wherein the non-conductive polymer binder comprises at least one of polyacrylic acid (PAA), carboxy methyl cellulose, and polyvinylidene fluoride (PVDF).

7. The dual fiber mat of claim 3, wherein the first type of nanofibers and the second type of nanofibers are distributed evenly in the fiber mat, such that the second type of nanofibers form fiber-fiber contact with the first type of nanofibers, and provide numerous node points and pathways for electrons to pass to/from the silicon nanoparticles or the PFM to a metal plate of the electrode.

8. The dual fiber mat of claim 3, wherein the first type of nanofibers have an average diameter of less than about 1 μm.

9. The dual fiber mat of claim 3, comprising about 50-80% of the first type of nanofibers and 20-50% of the second type of nanofibers.

10. The dual fiber mat of claim 3, wherein the second type of nanofibers comprises about 30-80% of the electrically conductive nanoparticles.

11. A dual fiber mat, comprising:
a first type of fibers having a first polymer and a first particle material; and
a second type of fibers having a second polymer and a second particle material.

12. The dual fiber mat of claim 11, wherein the first particle material comprises first nanoparticles or first nanorods.

13. The dual fiber mat of claim 12, wherein the first particle material comprises silicon nanoparticles or silicon nanorods or TiO₂ nanoparticles.

14. The dual fiber mat of claim 12, wherein the first particle material comprises LiCoO₂, LiFeO₂, sulfur-loaded carbon particles, or Li₂MnO₃, and other spinel and olivine structured materials

15. The dual fiber mat of claim 11, wherein each of the first polymer and the second polymer comprises a polyfluorene derivative polymer (PFM or PEFM).

16. The dual fiber mat of claim 11, wherein the second particle material comprises electrically conductive particles.

17. The dual fiber mat of claim 16, wherein the second particle material comprises carbon nanoparticles or copper nanoparticles.

18. The dual fiber mat of claim 11, wherein the first and second polymer has a formula of: 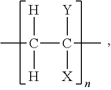
where each of X and Y is selected from —H, —OH, —COOH, and a halide.

19. The dual fiber mat of claim 18, wherein the second polymer comprises at least one of PAA and PVDF.

20. The dual fiber mat of claim 11, wherein the first type of fibers and the second type of fibers are distributed evenly in the fiber mat, such that the second type of fibers form fiber-fiber contact with the first type of fibers, and provide numerous node points and pathways for electrons to pass to/from the first nanoparticles or the first polymer to a metal plate of the electrode.

21. The dual fiber mat of claim 11, wherein a thickness of the dual fiber mat is about 50-1000 μm, and a diameter of the first type of fiber is less than 1 μm.

22. The dual fiber mat of claim 11, wherein the dual fiber mat comprises about 50-80% of the first type of fibers and about 20-50% of the second type of fibers, and the second type of fibers comprises about 30-80% of the second particles.

23. A multiple fiber mat electrode comprising a multiple fiber mat, wherein the multiple finer mat has two or more types of fibers, containing different particles and/or polymer binders.

24. The multiple fiber mat electrode of claim 23, wherein the electrode is used in an electrochemical device or process.

25. The multiple fiber mat electrode of claim 24, wherein the electrochemical device comprises at least one of a battery, a fuel cell, a water electrolyzer, an electrochemical reactor and a sensor.

26. A method of manufacturing a dual fiber mat for an electrode, comprising:
providing a first solution having a first polymer and a first particle material, and a second solution having a second polymer and a second particle material; and
co-spinning the first solution and the second solution to respectively form first fibers and second type of fibers, so as to form the dual fiber mat.

27. The method of claim 26, wherein the first particle material comprises silicon nanoparticles or silicon nanorods or TiO₂ nanoparticles, and the first polymer comprises PFM or PEFM or PAA or PVDF.

28. The method of claim 26, wherein the first particle material comprises LiCoO₂, LiFeO₂, sulfur-loaded carbon particles, Li₂MnO₃, or another spinel or olivine material and the first polymer comprises PFM or PEFM or PAA or PVDF.

29. The method of claim 26, wherein the second particle material comprises electrically conductive particles.

30. The method of claim 29, wherein the electrically conductive particles comprises carbon nanoparticles or copper nanoparticles.

31. The method of claim 26, wherein the second polymer comprises polyfluorene derivative polymer (PFM or PEFM), PAA, or PVDF.

32. The method of claim 26, wherein the dual fiber mat has a thickness of about 50-1000 μm.

33. The method of claim 26, wherein a diameter of the first type of fiber is less than 1 μm.

34. The method of claim 26, wherein the dual fiber mat comprises about 50-80% of the first type of fibers and about 20-50% of the second type of fibers, and the second type of fiber comprises about 30-80% of the second particles.

35. The method of claim 26, wherein the first type of fibers are silicon/PFM or silicon/PEFM fibers, and the second type of fibers are carbon/PVDF fibers.

36. The method of claim 26, wherein the first type of fibers are silicon/PAA fibers, and the second type of fibers are carbon/PAA fibers.

37. The method of claim 26, further comprising providing a third, fourth, or fifth solution having a third, fourth, or fifth particle material and a third, fourth, or fifth polymer, wherein the third, fourth, or fifth solution is co-spun with the first solution and the second solution to form third, fourth, or fifth fibers.

38. The method of claim 37, where there are three different fibers, the third particle material comprises at least one of silicon nanoparticles, silicon nanorods, carbon nanoparticles, and copper nanoparticles, and the third polymer comprises at least one of PFM, PEFM, PAA, and PVDF.
